(19) United States
(12) Patent Application Publication
(10) Pub. No.: US 2009/0036281 A1
(43) Pub. Date: Feb. 5, 2009

(54) Work piece support

(75) Inventor: David C. Piggott, Lakefield (CA)

Correspondence Address: Ralph A. Dowell of DOWELL & DOWELL P.C., 2111 Eisenhower Ave, Suite 406, Alexandria, VA, 22314, US

(73) Assignee: QUICKMILL INC., Peterborough (CA)

(21) Appl. No.: 12/213,588

(22) Filed: Jun. 20, 2008

Related U.S. Application Data
(60) Provisional application No. 60/929,511, filed on Jun. 29, 2007.

(51) Int. Cl. B23Q 3/157; B25B 5/14; B23C 3/00; G06F 19/00

(52) U.S. Cl. 483/54; 269/104; 409/132; 700/177

(57) ABSTRACT

There is provided a support assembly and method for supporting a work piece in a milling process comprising an anchor portion for securing to a work surface; a locating portion operable to nest with the anchor portion; and a tubular support member, the tubular support member operable to nest with the locating portion, the tubular support member having opposed support surfaces for supporting a work piece on the work surface.

### REFERENCE TO CO-PENDING APPLICATION

The entire subject matter of U.S. Provisional application 60/929,511 filed Jun. 29, 2007 and entitled WORK PIECE SUPPORT is incorporated herein by reference. The applicant claims priority benefit under Title 35, United States Code, Section 119 of the above application. The entire subject matter of U.S. Provisional application Ser. No. 60/874,949 filed Dec. 15, 2006 and entitled PROFILE CHARACTERIZATION is incorporated by reference. The entire subject matter of U.S. Provisional application Ser. No. 60/830,617 filed Jul. 14, 2006 and entitled CLAMPING DEVICE is incorporated by reference.

### FIELD OF THE INVENTION

The present invention relates to an assembly and method supporting a work piece, such as those used in a drilling process on a milling machine or other work piece processing machine.

### DESCRIPTION OF THE RELATED ART

The precision machining of large work pieces, such as plate-like work pieces, requires the use of a wide array of machine tools such as gauges, templates, cooling systems, hydraulic clamps, and drill-sets. These tools are expensive to acquire and maintain. A milling machine is a machine tool used for the complex shaping of metal and other solid materials. In its basic form the machine is a rotating cutter that rotates about a spindle, and a table to which the work piece is affixed. Milling machines can perform a vast number of complex operations, such as slot cutting, planning, drilling, rebating, routing, etc. Milling machines may be operated manually or under computer control. Large work pieces, such as steel plates, are frequently manufactured using a large gantry milling machine under computer numerical control (CNC).

In one conventional system, steel plates are stacked on a milling table and clamped at regular locations along their aligned peripheries so as not to interfere with the machining process, which may involve one or more milling and/or drilling steps. A gantry is configured to move along tracks that extend parallel to the work pieces, such that the gantry provides an overhead tool head to support for one or more machining tools. The gantry may be adjusted along the length of the work pieces, and the tool head may be adjusted by the CNC control along x, y and z axes relative to the work pieces to machine the work pieces.

As the process proceeds, the rotating cutter head works through the work piece, typically requiring the work piece to be supported above the milling table to mitigate damage. Further, there is the potential for the rotating cutter head being deviated, miss aligned or even have premature wear as the cutter head works through the work piece and engages a work piece support or the milling table.

### BRIEF DESCRIPTION OF THE DRAWINGS

Several preferred embodiments of the present invention will be provided, by way of examples only, with reference to the appended drawings, wherein,

FIG. 1 is an exploded view of a plurality of support assemblies for supporting a work piece;

FIG. 1a is a top view of one support assembly of FIG. 1, in another configuration;

FIG. 1b is a top view of another support assembly in the configuration of FIG. 1a;

FIGS. 2a to 2i are fragmented side views of the support device in the milling process;

FIG. 3 is a view of a support assembly kit;

FIG. 4 is a view of an alternative support assembly kit;

FIG. 5 is an operational view of a machining installation; and

FIG. 6 is an operational view of a portion of the installation of FIG. 5.

### DESCRIPTION OF THE PREFERRED EMBODIMENTS

It should be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Furthermore, and as described in subsequent paragraphs, the specific mechanical configurations illustrated in the drawings are intended to exemplify embodiments of the invention. However, other alternative mechanical configurations are possible which are considered to be within the teachings of the instant disclosure. Furthermore, unless otherwise indicated, the term “or” is to be considered inclusive.

As will expanded upon below with reference to the figures, there is provided, in an embodiment, a support assembly for supporting a work piece in a milling process comprising: an anchor portion for securing to a work surface, a locating portion that is operable to nest with the anchor portion; and a tubular support member, the tubular support member is operable to nest with the locating portion. The tubular support member has opposed support surfaces for supporting the work piece on the work surface.

As discussed below the anchor portion is removably securable to the work surface. In this example, the anchor portion includes a threaded bolt to threadably engage a threaded passages in the work surface.

The locating portion has an inner diameter sufficient to nest with an outer diameter of the anchor portion. The locating portion in this example is a disk, and the disk is of a sufficient thickness to maintain the tubular support member when the opposed support surfaces are damaged, for example notches and/or cuts that may occur from the milling process.

The tubular support member has an inner diameter sufficient to engage with an outer diameter of the locating portion. The tubular support member is a thin-walled cylindrical structure. The tubular support members are cut sections from thin walled aluminum pipe. The tubular support members may be circular or noncircular in cross section. The noncircular cross section may be for example square, triangular and/or multi-sided such as hexagonal. The tubular support members are of substantially identical dimensions. The tubular support member is, in one example, formed from a material having a hardness less than a work piece to be machined.

In an embodiment, there is provided a machining installation comprising:
a work piece support, the work piece support including a work surface, the work surface having a plurality of anchor locations, a tool head located above the work surface to machine a plurality of work pieces;
a plurality of anchor portions, each anchor portion to engage the work surface at a corresponding anchor location, each anchor portion having a first outer surface;
a plurality of locating portions, each locating portion having a first inner surface to engage the first outer surface of a corresponding anchor portion;
a plurality of tubular support members, each tubular support member having opposing end portions providing opposed parallel first and second support surfaces and a second inner surface, the second inner surface being operable to engage the first outer surface on a corresponding anchor portion; and
one of the work pieces having a third surface facing the work surface, each tubular support member being positioned between the work surface and the third surface, with the first support surface engaging the work surface and the second support surface engaging the third surface.

In an embodiment, the tubular support member is cylindrical.

In another embodiment, the tubular support member having a circular or noncircular cross section.

In yet another embodiment, the noncircular cross section is rectangular, square, triangular and/or multisided.

In yet another embodiment, each anchor location including a passage, each anchor portion including a pin to engage a corresponding passage.

In an embodiment, the pin and passage is threaded.

In an embodiment the pin is partially threaded into the passage with a portion of the pin exposed above the work surface.

In an embodiment the tubular support members is cut sections from thin walled aluminum pipe.

In an embodiment the tubular support members is of substantially identical dimensions.

In an embodiment the location portion is shaped like a toroid.

In yet another embodiment, the tool head is arranged to perform a series of machining steps on a first of the work pieces or a stack thereof, the tool head including a work tool to form a passage in the first work piece, the tool head being operable to cause the work tool to extend beyond the third surface, the tubular support member having a side wall, the side wall is arranged to be machined by the work tool to form at least one machined notch in the side wall adjacent the second support surface.

In another embodiment, the tubular support member is operable, after completion of the machining steps on the first work piece, to be reversed with the second support surface engaging the work surface and for the first support surface to engage a second work piece or a stack thereof, for a repetition of the machining steps on the second work piece, the tubular support member is of sufficient dimension for the second support surface to provide sufficient support for the second work piece, despite the presence of at least one machined notch in the side wall adjacent the second support surface.

In an embodiment, the locating portion having a thickness to exceed a depth dimension of the at least one machined notch from the first support surface.

In another embodiment, there is provided a method of machine successive groups of planar work pieces, comprising:
providing a work piece support with work surface and a tool head located above the work surface to machine a plurality of work pieces;
providing the work surface with a plurality of anchor locations;
considering an upcoming machining operation for machining a first group of one or more work pieces;
designating a group of anchor locations for the upcoming machine operation,
installing an anchor portion at each of the designated group of anchor locations so that each anchor portion has an exposed first outer surface;
providing a group of locating portions, each locating portion having a first inner surface,
engaging each locating portion with a corresponding anchor portion with each first inner surface on the locating portion engaging the first outer surface on the corresponding anchor portion;
providing a group of tubular support members, each tubular support member having opposing end portions providing opposed parallel first and second support surfaces and a second inner surface,
engaging each tubular support member with a corresponding locating portion at the work surface, with the first support surface engaging the work surface and each second inner surface of the tubular support member engaging the first outer surface on the corresponding locating portion;
providing a first group of one or more work pieces with a third surface to face the work surface;
positioning the first group of one or more work pieces in an operative position with the third surface engaging the second support surfaces of the tubular support members;
securing the first group in the operative position;
performing a first series of one or more machining steps on a first group, thereby to cause the tool head to form a passage in the first group, thereby to cause the work tool to extend beyond the third surface, the tubular support member having a side wall, the side wall being arranged to be machined by the work tool to form at least one machined notch in the side wall adjacent the second support surface.
releasing the so-machined first group of work pieces from engagement with the second support surfaces;
reversing with the tubular supports so that both the second support surface engages the work surface and each notch faces the work surface, the first support surface is in a ready position to receive a second group of one or more work pieces;
providing the second group of one or more work pieces with a fourth surface to face the work surface;
positioning the fourth group in an operative position with the fourth surface engaging the first support surfaces of the tubular support members;
securing the fourth group in the operative position;
performing a second series of one or more machining steps on a second group, thereby to cause the tool head to form a passage in the second group, thereby to cause the work tool to extend beyond the fourth surface;
and in an earlier process step, providing the tubular support with sufficient dimensions to provide sufficient support for the second group of work pieces when the second support surface engages the work surface, despite the presence of the notch in the side wall adjacent the second support surface.

In yet another embodiment there is provided a computer implemented method of preparing a gantry milling machine for machining a group of work pieces, comprising:
loading into computer memory a first data set representative of plurality of anchor locations on a gantry milling machine work surface;
loading into computer memory a second data set representative of dimensional coordinates for a work piece
determining a group of anchor locations, each is a candidate to receive an individual work piece support according to the second data set or calculations therefrom;
enabling a gantry milling machine tool head to be dispatched to a provisional one of the anchor locations to deliver an anchor portion to an operative position at the provisional anchor location;
establishing a routine for the tool head to be dispatched to each one of the group of anchor locations to deliver an anchor portion to the operational position at each anchor location.

In an embodiment, the action to deliver includes equipping the tool head with a tool to engage a set screw located at the anchor location and partially retracting the set screw so that a portion of the set screw is above the work surface.

In yet another embodiment, there is provided a method of locating spacers for a milling process comprising:
examining the steps of the milling process;
calculating the required spacers to support a work piece on a work surface;
calculating the locations of the required spacers so contact to the spacers by the milling process is minimized;
locating an anchor portion at the calculated locations;
nesting a support portion with the anchor portion; and mating the spacer with the support portion.

In still another embodiment there is provided a spacer kit for a milling process comprising:
a plurality of anchor portions for securing to a work surface;
a plurality of support portions operable to nest with the anchor portions;
a plurality of spacer, the spacer being operable to mate between said support portions and a work piece; and
an instructional description and method to use the spacer kit.

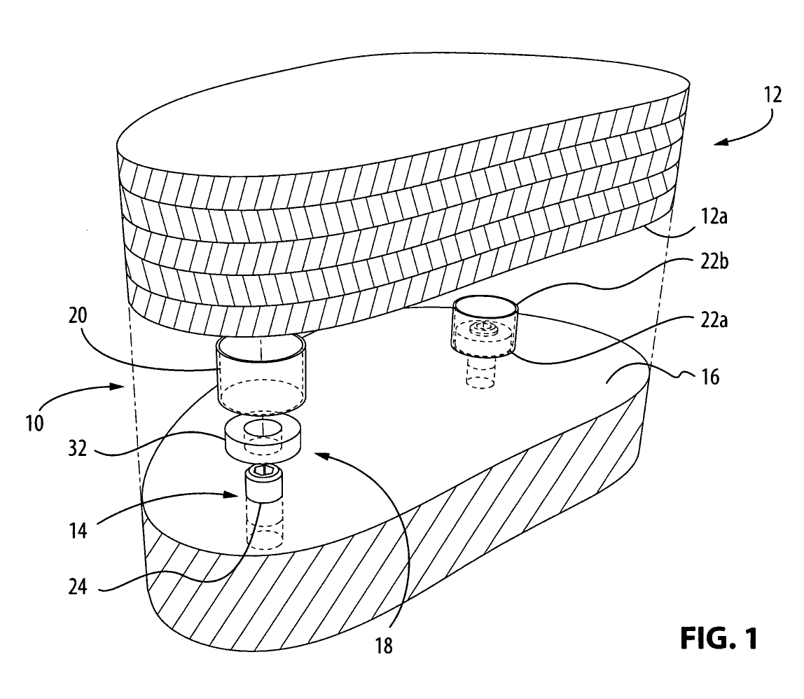

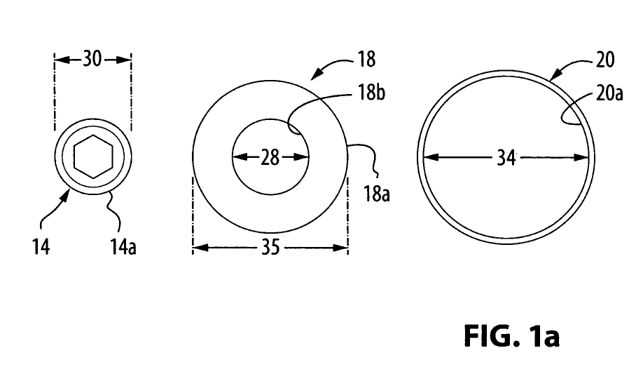

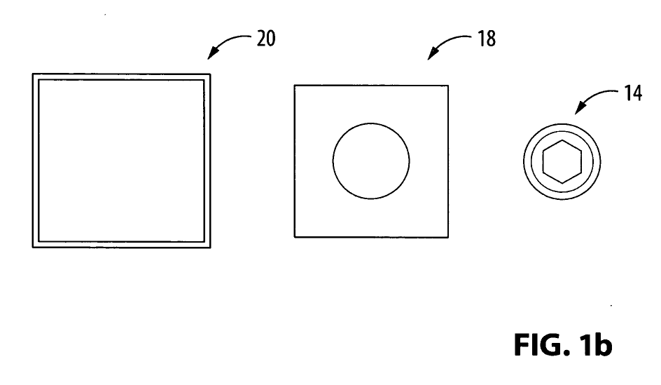

Referring now to the figures, particularly FIG. 1 there is provided a support assembly shown generally at 10 for supporting a work piece 12, or a stack or group of one of more thereof, in a milling process. FIG. 1 shows two such support assemblies. Each includes an anchor portion 14 for securing to a work surface 16. A locating portion 18 is operable to nest with the anchor portion 14. A tubular support member 20 is operable to nest with the locating portion 18. The tubular support member 20 has opposed support surfaces 22a, 22b for supporting the work piece 12 on the work surface 16.

The anchor portion 14 includes a threaded bolt or pin 24 to threadably engage a threaded passage 26 in the work surface 16. Other configurations may be utilized to removably secure the anchor portion 14 to the work surface 16 for example other fastener configurations, a magnet, adhesive, and/or welding. The threaded bolt or pin may be partially threaded into the passage with a portion of the pin exposed above the work surface. The passage may be a notch or groove or be provided in an intermediate object or support otherwise mounted on or to the work surface 16.

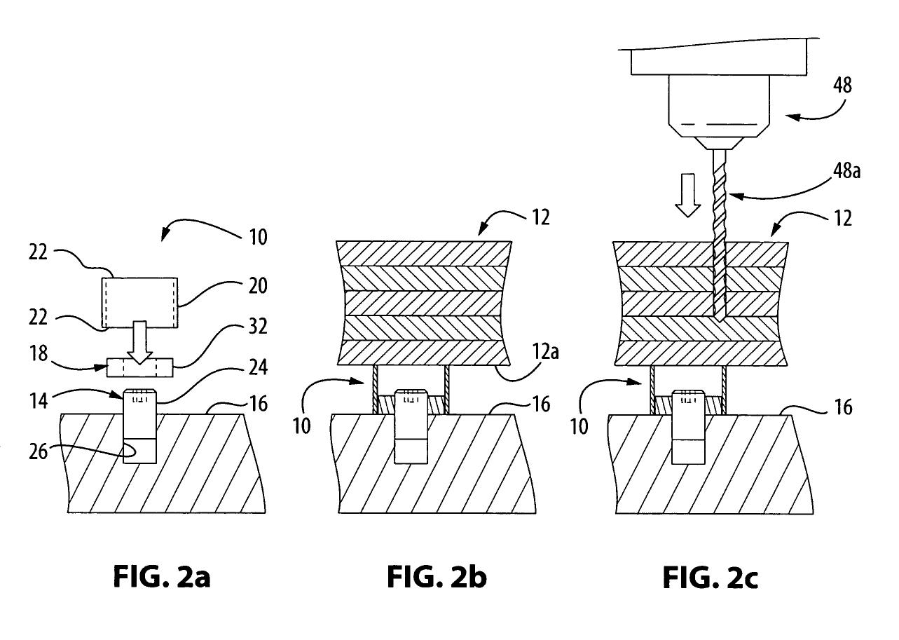

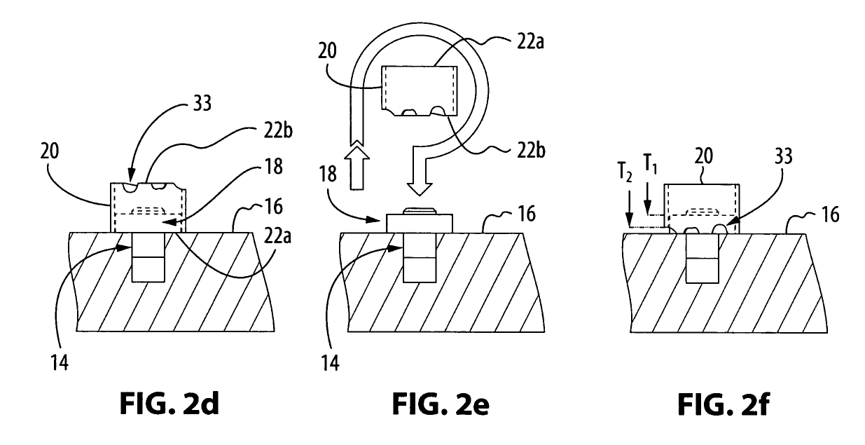

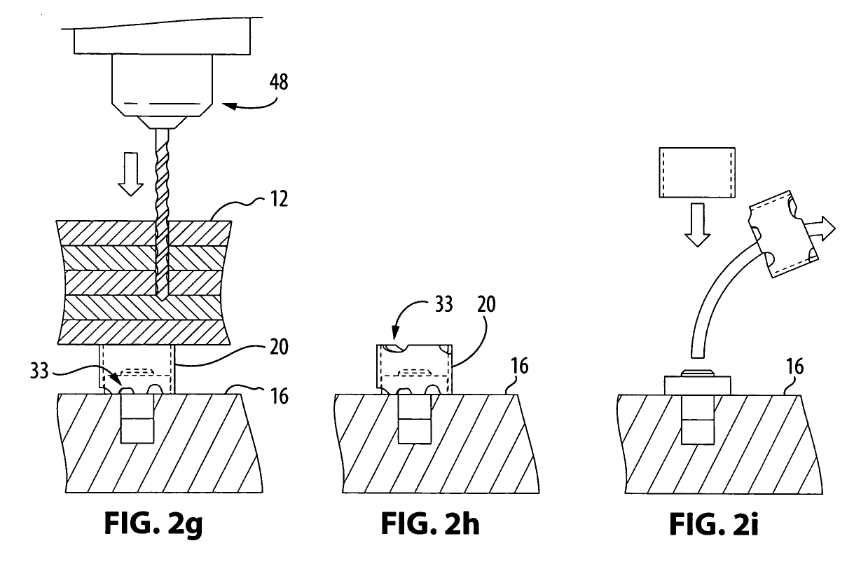

As shown in FIGS. 1a and 2a, the locating portion 18 has an inner diameter 28, sufficient to nest with an outer diameter 30 of the anchor portion 14 as shown in FIG. 1a. The locating portion 18 in this example includes a disk 32 which is of a sufficient thickness to maintain the tubular support member 20 when the opposed support surfaces 22 are damaged, for example with notches and/or cuts shown generally at 33 that may occur from the milling process as illustrated in the FIGS. 2a through 2i.

As illustrated in FIGS. 1a and 2a, the tubular support member 20 has an inner diameter 34 sufficient to engage with an outer diameter 35 of the locating portion 18. The tubular support member 20 is a thin-walled cylindrical structure and, in this example, may be formed as a cut section from a thin walled aluminum pipe such as with a wall thickness ranging from about 0.050 inches (1.25 mm) to 0.125 inches (3.2 mm). The tubular support member 20 may be circular or noncircular in cross section. The noncircular cross section may be, for example, rectangular, square, triangular and/or oval as shown in FIG. 1b. The tubular support member is of substantially identical dimensions but may be of different sizes for example to machine a work piece with a stepped third surface (not shown). The tubular support member 20 may be of a range of materials and may include a material having a hardness less than that of the work piece 12.

A plurality of the support assemblies 10 may be employed to support one or more work pieces 12. Each of the locating portions 18 has a first outer surface portion 18a, and a first inner surface portion 18b to engage the second outer surface 14a of a corresponding anchor portion 14. Each of the tubular support members 20 has opposing end portions that provide opposed parallel first and second support surfaces 22a, 22b and a second inner surface 20a. The second inner surface 20a is operable to engage the first outer surface 14a on a corresponding anchor portion 14. As can been in FIG. 1, one of the work pieces 12 has a third surface 12a facing the work surface 16, and each tubular support member 20 is positioned between the work surface 16 and the third surface 12a. In one orientation, the first support surface 22a engages the work surface 16 and the second support surface 22b engages the third surface 12a. In another orientation, the support surfaces may be reversed to allow the tubular support member 20 to be used in two processing operations.

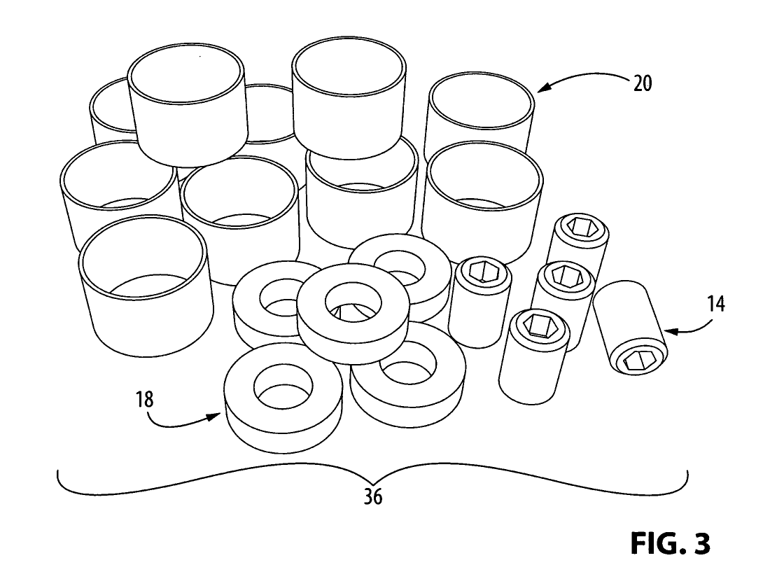

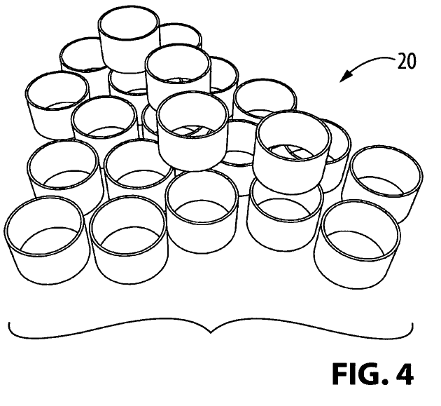

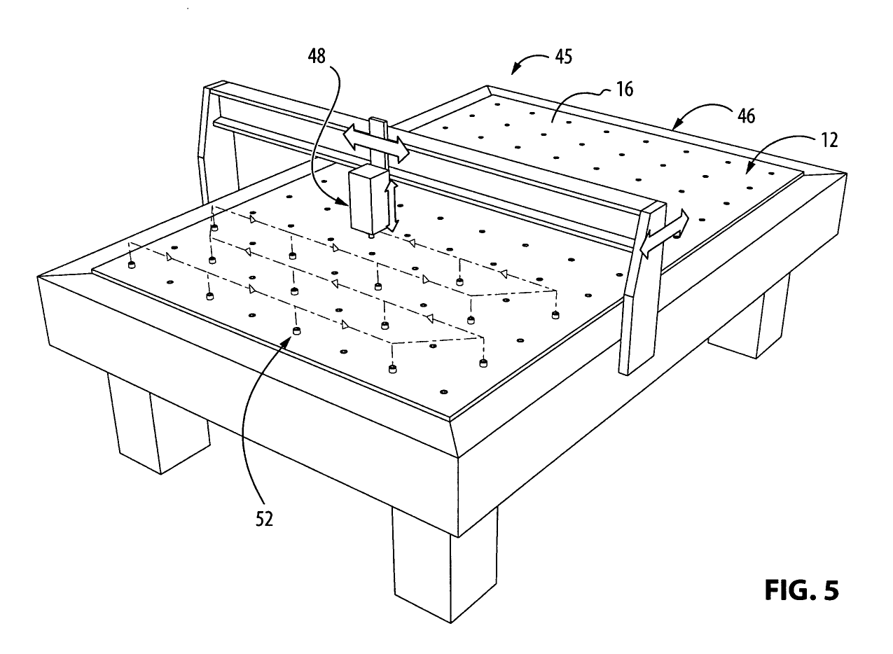

As shown in FIG. 3, a kit 36 may be provided to prepare a processing machine. This kit in this case includes a collection of tubular support members 20, locating portions 18 and anchor portions 14, though these may be provided separately as desired, such as in the form of kit in FIG. 4 which includes only tubular support members 20. The kit of FIG. 4 may be useful as a supplementary kit to the kit of FIG. 3, since the anchor portions and the locating portions may be reused indefinitely while the tubular support members are consumed by the processing the work pieces as will be described, while the anchor portions may be provided with the milling machine, as is the case with milling machines commercially available under the trademark QUICKMILL. If desired, the kits 36 of FIGS. 3 and 4 may also be prepared with instructions or other guidance, for installation, which may be provided in writing, graphical, textual video formats or may be provided with an internet address to a page on the internet providing such guidance.

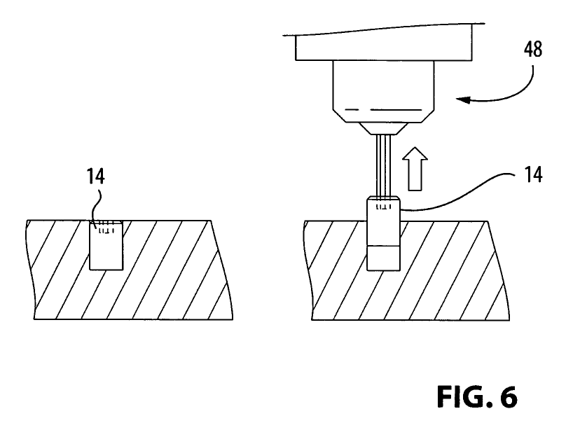

As shown in FIG. 5, the support assembly may be used in a machining installation with a gantry milling machine 45 including a work surface 16, with a plurality of anchor locations 46 and a tool head 48 located above the work surface 12 to machine a plurality of work pieces (not shown). A plurality of anchor portions 14 are provided each being able to engage the work surface 16 at a corresponding anchor location 46.

As illustrated if FIG. 2c, the tool head 48 may be arranged to perform a series of machining steps on a first of the work pieces or a set of first work pieces 12 in this case. The tool head 48 includes a work tool 48a to form a passage in the first work pieces and to cause the work tool 48a to extend beyond the third surface 12a. The tubular support members 20 are located in positions allowing them to provide the support needed to secure the work pieces 12 in position. This will of course be determined by the size of the work pieces 12 and the size and nature of the passages or other work forming steps to be performed on the work pieces 12. Consequently, some of the tubular support members 20 may lie in the path of the work tool 48a as it process through its process steps. To accommodate this, the tubular support member 20 has a side wall which is arranged to be machined by the work tool to form at least one machined notch or cut, as illustrated in FIGS. 2d through 2i at 33 in the side wall adjacent the first support surface.

As shown in FIGS. 2d through 2f the tubular support member 20 is operable after completion of the machining steps on the first work piece, to be reversed with the second support surface 22b engaging the work surface and for the first support surface 22a to engage a second work piece, or stack thereof, for a repetition of the machining steps on the second work piece. The tubular support 20 is thus of sufficient dimension for the first and second support surfaces 22a, 22b to provide sufficient support for a second work piece, despite the presence of the notch or cuts 33 in the side wall adjacent one or both support surfaces.

In this case, the locating portion 18 has a thickness “T₁” (FIG. 2f) to exceed a depth dimension “T₂” of the machined recess 33 from the second support surface 22b. In this example the locating portion 18 is toroidally shaped, but other shapes may be utilized for example rectangular, square, triangular and/or oval, while being complementary with the shape of the tubular support member 20.

The kit may be used in connection with an installation as above described for machining, for instance, successive groups of stacked planar work pieces. The kit may be used either in an entirely manual operation or in a partially or fully automated procedure.

In the former instance, the gantry milling machine 45 may thus be prepared with the tool head 48 located above the work surface 16 to machine a plurality of work pieces 12. The operator considers an upcoming machining operation for a first group of one or more work pieces 12 and designates a group of anchor locations 46 for the upcoming machine operation. The operator may then manually install an anchor portion at each of the designated group of anchor locations 46 so that the anchor portion has an exposed first outer surface.

Alternatively, one or more computer program steps may be initiated to prepare or access from memory a data structure representative of a map or pattern of suitable anchor locations while taking into account the dimensions of the work piece 12. With the pattern established, the tool head 48 may be used to install the anchor portions 14, which may be resident in the anchor locations 46 as provided as original equipment on the gantry milling machine 45. Thus, the tool head 48 may be deployed to advance from one anchor location to another, as shown by the chain dotted path in FIG. 5 and at each anchor location, to engage the anchor portion and partially unthread the anchor portion 14 from its normal assembly position beneath the work surface 16 to a prone intermediate position above the work surface as shown in FIG. 5.

Alternatively, the tool head 48 may be instructed, through a series of computer commands, to access an anchor portion 14 from a storage location, to deliver the anchor portion to a designated anchor location 46 and to thread the anchor portion 14 therein. The tool head 48 may then be commanded to repeat these steps until all designated anchor portions 14 in the pattern are in their ready position.

Next, a locating portion 18 and tubular support member 20 may be installed on each operative anchor portion 14. This may similarly be done manually or be computer implemented with a suitably equipped gripping member (not shown) on the tool head 48.

With the work surface 16, anchor portions 14, locating portions 18 and tubular support members 20 in position, the first group of one or more work pieces 12 may be placed in an operative position with the third surface engaging the first support surfaces of the tubular support members 20. The first group may thus be secured in the operative position using one or more clamps or the like, such as those described in U.S. Provisional application Ser. No. 60/830,617 filed Jul. 14, 2006 and entitled CLAMPING DEVICE.

The gantry milling machine 45 may then be configured to perform a first series of one or more machining steps on the first group of work pieces 12, thereby to cause the tool head to form a passage in the first group, causing the work tool 48a to extend beyond the third surface 12a, causing machined notches 33 to appear in the side wall of the tubular support member 20 adjacent the first support surface 22c, for those tubular support members 22 in the path of the work tool 48a.

The operator then releases the so-machined first group of work pieces 12 from engagement with the second support surfaces 22b and reverses the tubular support members so that both the second support surface 22b, with the notch 30, faces the work surface 16 with the first support surface 22a in a ready position to receive a second group of one or more work pieces 12.

The operator then installs a second group of one or more work pieces 12 to repeat the process steps.

Thus, the tubular support members 20 are provided with sufficient dimensions to provide sufficient support for the second group of work pieces when the second support surface 22b engages the work surface 16, despite the presence of the notch 33 in the side wall adjacent the first support surface 22a.

Thus, in one embodiment, a computer implemented method of preparing a gantry milling machine 45 is provided with the step of loading into a computer memory a first data set representative of plurality of anchor locations on a gantry milling machine work surface and loading a second data set representative of dimensional coordinates for a work piece. This may be followed by the step of determining, or accessing data indicative of, a group of anchor locations may then be determined, which are candidates to receive an individual work piece support according to the second data set or calculations there from to enable the gantry milling machine tool head to be dispatched to a provisional one of the anchor locations to deliver an anchor portion to an operative position at the provisional anchor location.

In another step, a routine may be established for the tool head to be dispatched to each one of the group of anchor locations to deliver an anchor portion to the operational position at each anchor location. In this case, the action to deliver may include equipping the tool head with a tool to engage a set screw located at the anchor location and partially retracting the set screw so that a portion of the set screw is above the work surface.

Thus, the computer implemented function of the gantry milling machine may be provided in a number of forms. The function may be embodied in a software program configured to run on one or more Computer Numerical Control (CNC) systems or general purpose computers, such as a personal computer, or on a more substantial computer mainframe. The general purpose computer may work within a network involving several general purpose computers, for example those sold under the trade names APPLE or IBM, or clones thereof, which are programmed with operating systems known by the trade names WINDOWS, LINUX or other well known or lesser known equivalents of these. The system may involve pre-programmed software using a number of possible languages or a custom designed version of a programming software sold under the trade name ACCESS or similar programming software. The computer network may be a wired local area network, or a wide area network such as the Internet, or a combination of the two, with or without added security, authentication protocols, or under “peer-to-peer” or “client-server” or other networking architectures. The network may also be a wireless network or a combination of wired and wireless networks. The wireless network may operate under frequencies such as those dubbed ‘radio frequency’ or “RF” using protocols such as the 802.11, TCP/IP, BLUE TOOTH and the like, or other well known Internet, wireless, satellite or cell packet protocols. The system may, alternatively, be executed on a single custom built computer or programmed logic controller which is dedicated to the function of the system alone.

While the present invention has been described for what are presently considered the preferred embodiments, the invention is not so limited. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A support assembly for supporting a work piece in a milling process comprising:
an anchor portion for securing to a work surface;
a locating portion operable to nest with the anchor portion; and
a tubular support member, the tubular support member operable to nest with the locating portion, the tubular support member having opposed support surfaces for supporting a work piece on the work surface.

2. An assembly as defined in claim 1, the anchor portion being removably securable to the work surface.

3. An assembly as defined in claim 2, the anchor portion including a threaded bolt to threadably engage threaded passages in the work surface.

4. An assembly as defined in claim 1, the locating portion having an inner diameter sufficient to nest with an outer diameter of the anchor portion.

5. An assembly as defined in claim 1, the locating portion including a disk.

6. An assembly as defined in claim 5, the disk being of a thickness sufficient to maintain the tubular support member.

7. An assembly as defined in claim 1, the tubular support member being a thin-walled cylindrical structure.

8. An assembly as defined in claim 1, the tubular support member having an inner diameter sufficient to engage an outer diameter of the locating portion.

9. An assembly as defined in claim 1, the tubular support member being formed from a material having a hardness less than a work piece to be machined.

10. A machining installation comprising:
a work piece support, the work piece support including a work surface, the work surface having a plurality of anchor locations, a tool head located above the work surface to machine a plurality of work pieces;
a plurality of anchor portions, each anchor portion to engage the work surface at a corresponding anchor location, each anchor portion having a first outer surface;
a plurality of locating portions, each locating portion having a first inner surface to engage the first outer surface of a corresponding anchor portion;
a plurality of tubular support members, each tubular support member having opposing end portions providing opposed parallel first and second support surfaces and a second inner surface, the second inner surface being operable to engage the first outer surface on a corresponding anchor portion; and
one of the work pieces having a third surface facing the work surface, each tubular support member being positioned between the work surface and the third surface, with the first support surface engaging the work surface and the second support surface engaging the third surface.

11. An installation as defined in claim 10, the tubular support member being cylindrical.

12. An installation as defined in claim 10, the tubular support member having a circular or noncircular cross section.

13. An installation as defined in claim 12, the noncircular cross section being rectangular, square, triangular and/or multifaced section such as a hexagon.

14. An installation as defined in claim 10, each anchor location including a passage, each anchor portion including a pin to engage a corresponding passage.

15. An installation as defined in claim 14, the pin and passage being threaded.

16. An installation as defined in claim 15, the pin being partially threaded into the passage with a portion of the pin exposed above the work surface.

17. An installation as defined in claim 10, the tubular support members being cut sections from thin walled aluminum pipe.

18. An installation as defined in claim 17, the tubular support members being of substantially identical dimensions.

19. An installation as defined in claim 10, the location portion being shaped like a toroid.

20. An installation as defined in claim 10, the tool head being arranged to perform a series of machining steps on a first of the work pieces or a stack thereof, the tool head including a work tool to form a passage in the first work piece, the tool head being operable to cause the work tool to extend beyond the third surface, the tubular support member having a side wall, the side wall being arranged to be machined by the work tool to form at least one machined notch in the side wall adjacent the second support surface.

21. An installation as defined in claim 20, the tubular support member being operable, after completion of the machining steps on the first work piece, to be reversed with the second support surface engaging the work surface and for the first support surface to engage a second work piece or a stack thereof, for a repetition of the machining steps on the second work piece, the tubular support member being of sufficient dimension for the second support surface to provide sufficient support for the second work piece, despite the presence of at least one machined notch in the side wall adjacent the second support surface.

22. An installation as defined in claim 21, the locating portion having a thickness to exceed a depth dimension of the at least one machined notch from the first support surface.

23. A method of machining successive stacked groups of planar work pieces or singular plates, comprising:
providing a work piece support with work surface and a tool head located above the work surface to machine a plurality of work pieces;
providing the work surface with a plurality of anchor locations;
considering an upcoming machining operation for machining a first group of one or more work pieces;
designating a group of anchor locations for the upcoming machine operation,
installing an anchor portion at each of the designated group of anchor locations so that each anchor portion has an exposed first outer surface;
providing a group of locating portions, each locating portion having a first inner surface,
engaging each locating portion with a corresponding anchor portion with each first inner surface on the locating portion engaging the first outer surface on the corresponding anchor portion;
providing a group of tubular support members, each tubular support member having opposing end portions providing opposed parallel first and second support surfaces and a second inner
surface,
engaging each tubular support member with a corresponding locating portion at the work surface, with the first support surface engaging the work surface and each second inner surface of the tubular support member engaging the first outer surface on the corresponding locating portion;
providing a first group of one or more work pieces with a third surface to face the work surface;
positioning the first group of one or more work pieces in an operative position with the third surface engaging the second support surfaces of the tubular support members;
securing the first group in the operative position;
performing a first series of one or more machining steps on a first group, thereby to cause the tool head to form a passage in the first group, thereby to cause the work tool to extend beyond the third surface, the tubular support member having a side wall, the side wall being arranged to be machined by the work tool to form at least one machined notch in the side wall adjacent the second support surface.
releasing the so-machined first group of work pieces from engagement with the second support surfaces;
reversing with the tubular supports so that both the second support surface engages the work surface and each notch faces the work surface, the first support surface is in a ready position to receive a second group of one or more work pieces;
providing the second group of one or more work pieces with a fourth surface to face the work surface;
positioning the fourth group in an operative position with the fourth surface engaging the first support surfaces of the tubular support members;
securing the fourth group in the operative position;
performing a second series of one or more machining steps on a second group, thereby to cause the tool head to form a passage in the second group, thereby to cause the work tool to extend beyond the fourth surface;
and in an earlier process step, providing the tubular support with sufficient dimensions to provide sufficient support for the second group of work pieces when the second support surface engages the work surface, despite the presence of the notch in the side wall adjacent the second support surface.

24. A computer implemented method of preparing a gantry milling machine for machining a group of work pieces, comprising:
loading into computer memory a first data set representative of plurality of anchor locations on a gantry milling machine work surface;
loading into computer memory a second data set representative of dimensional coordinates for a work piece
determining a group of anchor locations, each being a candidate to receive an individual work piece support according to the second data set or calculations therefrom;
enabling a gantry milling machine tool head to be dispatched to a provisional one of the anchor locations to deliver an anchor portion to an operative position at the provisional anchor location;
establishing a routine for the tool head to be dispatched to each one of the group of anchor locations to deliver an anchor portion to the operational position at each anchor location.

25.-27. (canceled)
